(19) United States
(12) Patent Application Publication
(10) Pub. No.: US 2006/0088335 A1
(43) Pub. Date: Apr. 27, 2006

(54) Image forming apparatus capable of changing positions of panels and method thereof

(76) Inventor: Young-min Choi, Seoul (KR)

Correspondence Address: STANZIONE & KIM, LLP, 919 18TH STREET, N.W., SUITE 440, WASHINGTON, DC, 20006, US

(21) Appl. No.: 11/251,893

(22) Filed: Oct. 18, 2005

(30) Foreign Application Priority Data
Oct. 27, 2004 (KR) 2004-86024

(51) Int. Cl. G03G 15/00

(52) U.S. Cl. 399/110

(57) ABSTRACT

An image forming apparatus including operation panels. The image forming apparatus includes a body, a plurality of connectors, each being formed at a predetermined position on the body, and a plurality of operation panels connected with the body through the plurality of connectors. Connecting positions of the plurality of operation panels are changeable by replacing panels with one another. Each connector has a plurality of sockets which are connectible with the plurality of operation panels so that each connector can be connected with any of the operation panels. Accordingly, the positions of the operation panels are changeable to achieve a convenient arrangement.

### CROSS-REFERENCE TO RELATED APPLICATIONS

This application claims the benefit under 35 U.S.C. §119 from Korean Patent Application No. 2004-86024, filed on Oct. 27, 2004, the entire contents of which are incorporated herein by reference.

### BACKGROUND OF THE INVENTION

1. Field of the Invention

The present general inventive concept relates to an image forming apparatus having operation panels and a method of changing positions of the operation panels. More particularly, the present general inventive concept relates to an image forming apparatus capable of changing positions of operation panels which are divided by function.

2. Description of the Related Art

With the development of electronic technology, image forming apparatuses having a variety of functions have been developed and are being widely utilized. A conventional image forming apparatus refers to an apparatus that scans images or prints images on paper, and includes a printer, a photocopier, a scanner, a facsimile machine, and a multifunction peripheral. In general, the conventional image forming apparatus is provided with an operation panel to allow a user to control operations of the conventional image forming apparatus. To actively utilize various functions provided by the conventional image forming apparatus, a size of a recently developed operation panel becomes large.

FIGS. 1A and 1B are views illustrating operation panels provided on conventional image forming apparatuses. Referring to FIG. 1A, an operation panel 10 is fabricated in an integrated form, which integrates an output window 11, numeric buttons 12, and a plurality of selection buttons 13 into a single operation panel. Since the integrated operation panel 10 is large in size, it is mainly used in a large and complex conventional image forming apparatus.

Referring to FIG. 1B, an operation panel may be divided into a plurality of panels and attached to a conventional image forming apparatus. Such a separable panel is mainly used in a small-sized conventional image forming apparatus which cannot use the integrated operation panel 10. The operation panel is divided into an output panel 20 and an input panel 25, and the respective output and input panels 20 and 25 are attached to different positions.

The operation panels as illustrated in FIGS. 1A and 1B are attached to fixed positions on the respective conventional image forming apparatuses. The output window 11 (or output panel 20) for displaying an operation status of the conventional image forming apparatus and a button key for inputting a selection signal are attached to fixed positions.

However, users have different individual habits and therefore a different number of times per period in which they use functions provided by the conventional image forming apparatus. Therefore, the use of the operation panel attached to a fixed position is inconvenient. For example, alphabet buttons located at the right side for the convenience of a right-handed person are inconvenient to a left-handed person. If a numeric button for inputting a fax number is attached to a center of the operation panel, a user who mainly uses a fax function feels inconvenienced when using the numeric button.

### SUMMARY OF THE INVENTION

The present general inventive concept provides an image forming apparatus having operation panels that can be placed at different positions according a user's selection.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing an image forming apparatus including a body, a plurality of connectors formed at a plurality of predetermined positions on the body, and a plurality of operation panels connected with the body through the plurality of connectors at connecting positions thereof. The connecting positions of the plurality of operation panels are changeable.

The body may include a plurality of bus lines that correspond to the plurality of operation panels.

Each connector of the plurality of connectors may include a plurality of sockets which is connectible with any of the plurality of operation panels. If a connector is connected to one of the plurality of operation panels, the connector connects the connected operation panel with a corresponding bus line.

The sockets may have different colors to distinguish operation panels connected to the respective sockets.

The plurality of operation panels may include at least one input panel to input a predetermined input signal, and at least one output panel to display an operation status according to the predetermined input signal.

The foregoing and/or other aspects of the present general inventive concept may also be achieved by providing an image forming apparatus including a body, and an operation panel connected with the body. The operation panel is divided into a predetermined number of panels, and the panels are changeable in position with respect to the body.

The body may include a plurality of bus lines corresponding to the panels, and a plurality of sockets to connect any panel with a corresponding at least one bus line.

The foregoing and/or other aspects of the present general inventive concept may also be achieved by providing a method of changing positions of panels in an image forming apparatus which has a plurality of panels. The method includes preparing a plurality of connectors on the image forming apparatus, each connector of the plurality of connectors being connectible with the plurality of panels, and changing positions of the plurality of panels and connecting the panels with the plurality of connectors.

The foregoing and/or other aspects of the present general inventive concept may also be achieved by providing an image forming apparatus interface to perform input and output operations, the image forming apparatus interface including a plurality of panels, at least two panels of the plurality of panels being changeable in position with respect to each other, and a plurality of connectors disposed thereon to connect with the plurality of panels, at least two of the plurality of connectors being connectable with the at least two panels.

The foregoing and/or other aspects of the present general inventive concept may also be achieved by providing an image forming apparatus including a body, an operation panel to perform input and output operations and including a plurality of panels, at least two of the plurality of panels being changeable in position with respect to each other, a plurality of connectors disposed at a plurality of locations on the body, each connector capable of connecting to one or more of the plurality of panels, and a plurality of bus lines, at least one bus line corresponding to each panel of the plurality of panels.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A and 1B illustrate operation panels provided on conventional image forming apparatuses;

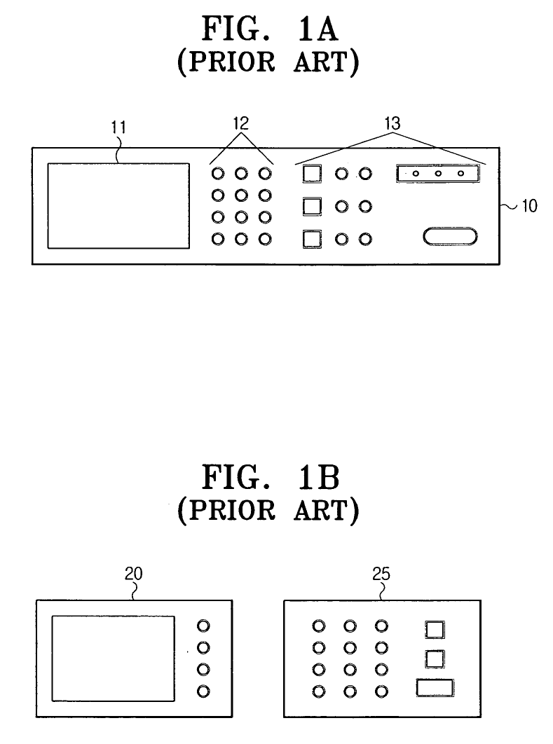

FIG. 2 illustrates an image forming apparatus according to an embodiment of the present general inventive concept;

FIG. 3 illustrates an exemplary connection part used in the image forming apparatus of FIG. 2;

FIGS. 4A through 4C illustrate alternative arrangements of the operation panels of the image forming apparatus of FIG. 2; and

FIGS. 5A and 5B illustrate operation panels according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

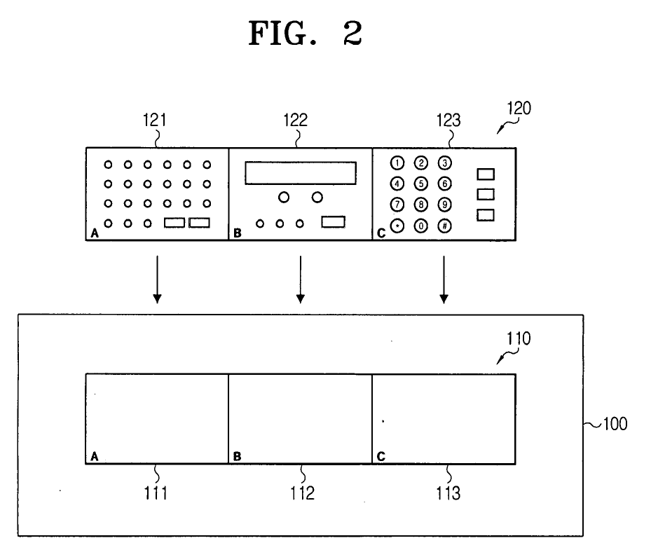

FIG. 2 is a view illustrating an image forming apparatus according to an embodiment of the present general inventive concept. Referring to FIG. 2, the image forming apparatus comprises a body 100, a connection part 110 and an operation panel 120.

The body 100 represents the image forming apparatus except the operation panel and the connection part. For the convenience of explanation, detailed illustrations of components of the body 100, such as a paper feeding part and a paper discharge part, are omitted.

The connection part 110 is disposed on a predetermined position of the body 100 to connect with the operation panel 120. The connection part 110 may be disposed on any place that can allow a user to view the connection part 110 easily. For example, the connection part 110 may be disposed on an upper surface or a front surface of the body 100.

The operation panel 120 is divided into a predetermined number of panels. In the embodiment illustrated in FIG. 2, the operation panel 120 is divided into a panel A 121, a panel B 122 and a panel C 123. The panel A 121 may be a letter input panel to input letters such as alphabets, the panel B 122 may be an output panel to display an operation status of the image forming apparatus, or inputted text or figures, and the panel C 123 may be a number input panel to input numbers. The output panel may be a liquid crystal display (LCD) window or a light emitting diode (LED). Albeit not illustrated in FIG. 2, a menu input panel (not shown) may be additionally provided on the image forming apparatus to select a menu and set a function. The operation panel functions as a user interface to communicate a user interaction with the image forming apparatus. The operation panel may be divided into panels according to functions provided by the image forming apparatus, for example, a letter input, a numeric input panel, an output panel (display), etc.

The connection part 110 may be divided into a connector A 111, a connector B 112, and a connector C 113 which correspond respectively to the panels 121, 122, and 123 in number. Each panel 121, 122, and 123 may be connected with the image forming apparatus at any of the connectors 111, 112, and 113 so that the panels 121, 122, and 123 can be disposed in different positions with respect to the body 100. That is, the panels are changeable in position with respect to each other and the connection part 110. In other words, the panel A 111 can be connected with the connector A 121, the connector B 112 or the connector C 113. The panel B 122 can be connected with the connector A 111, the connector B 112 or the connector C 113, and the panel C 123 can be connected with the connector A 111, the connector B 112, or the connector C 123.

Accordingly, a user can decide the positions at which to place the output panel 122, the number input panel 123, the letter input panel 121 and the menu input panel according to a desired order.

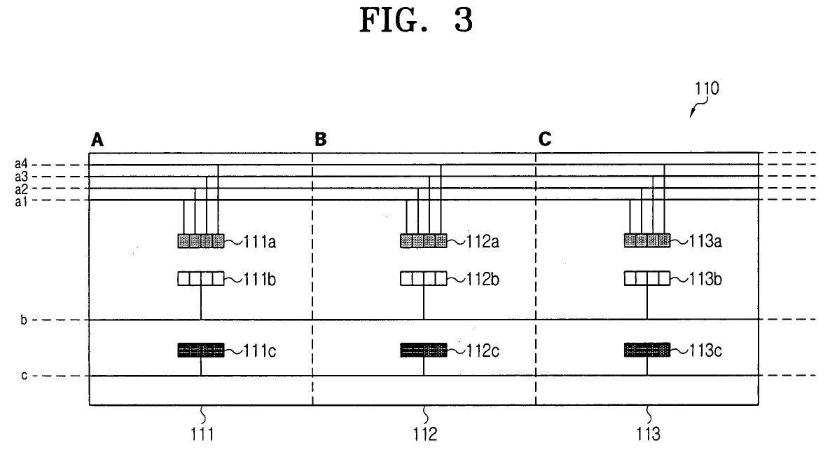

FIG. 3 illustrates an exemplary connection part 110 fabricated to be connectible with any of the panels 121, 122, and 123. As illustrated in FIGS. 2 and 3, the connection part 110 is divided into the connector A 111, the connector B 112, and the connector C 113. However, this should not be considered as limiting. The connection part 110 may include more than three connectors.

Referring to FIG. 3, each connector 111, 112, and 113 has sockets that correspond to the panels 121, 122, and 123. Each socket may connect and secure one of the panels 121, 122, or 123 to the body 100.

For example, the connector A 111 has a socket A 111a, a socket B 111b, and a socket C 111c which correspond to the panel A 121, the panel B 122, and the panel C 123, respectively. Each of the sockets 111a, 111 b, and 111c is connected with a corresponding bus line (or corresponding bus lines) provided in the body 100. More specifically, the socket A 111a is connected to bus lines a1 to a4, the socket B 111b to a bus line b, and the socket C 111c to a bus line c.

The bus lines a1 to a4, b, and c are connected with a controller (not shown) disposed in the image forming apparatus to transmit input signals to the controller or to receive control signals from the controller.

The connector B 112 and the connector C 113 respectively have sockets A 112a and 113a, sockets B 112b and 113b, and sockets C 112c and 113c. Accordingly, each connector 111, 112, and 113 may be connected with any of the panels 121, 122, and 123 so that the panels 121, 122, and 123 can change positions with one another.

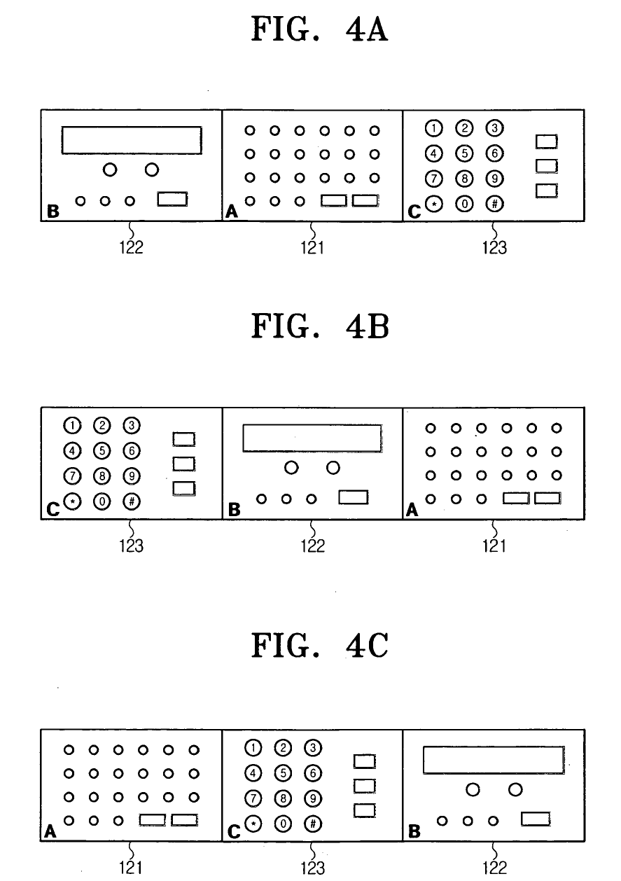

FIGS. 4A to 4C are views illustrating alternative arrangements of the panels 121, 122, and 123.

As illustrated in FIG. 4A, the panels are arranged in an order B, A and C from left to right. To arrange the panels as illustrated in FIG. 4A, the panel B 122 is connected with the socket B 111b of the connector A 111, the panel A 121 is connected with the socket A 112a of the connector B 112, and the panel C 123 is connected with the socket C 113c of the connector C 113.

An operation of the image forming apparatus in which the panels are arranged as illustrated in FIG. 4A is explained below when the panel A 121 is a letter input panel, the panel B 122 is an output panel, and the panel C 123 is a number input panel. When a user selects a certain letter through the panel A 121, information about the selected letter is transmitted to the bus lines a1 through a4 through the socket A 112a of the connector B 112. Accordingly, the controller comprehends the selected letter and transmits the letter information to the panel B 122 through the bus line b and the socket B 111b. The panel B 122 displays the transmitted letter information on a screen.

If a frequent user is a right-handed person and mainly uses the number input panel, the panels 121 to 123 may be arranged as illustrated in FIG. 4A for the convenience of the right-handed user.

Alternatively, the panels 121, 122, and 123 may be arranged in the order of C, B, A as illustrated in FIG. 4B by connecting the panel C 123 with the socket C 111c of the connector A 111, connecting the panel B 122 with the socket B 112b of the connector B 112, and connecting the panel A 121 with the socket A 113a of the connector C 113.

Yet alternatively, the panels 121, 122, and 123 may be arranged in the order of A, C and B as illustrated in FIG. 4C for the convenience of a left-handed person.

If another user uses the panels 121, 122, 123 or a most frequently used function is changed, the panels 121 to 123 may be disconnected from the connectors 111, 112, and 113, and may be connected with the connectors 111, 112, and 113 in a desired order so that the panels 121, 122, and 123 can be easily changed in position, that is, placed according to a different arrangement.

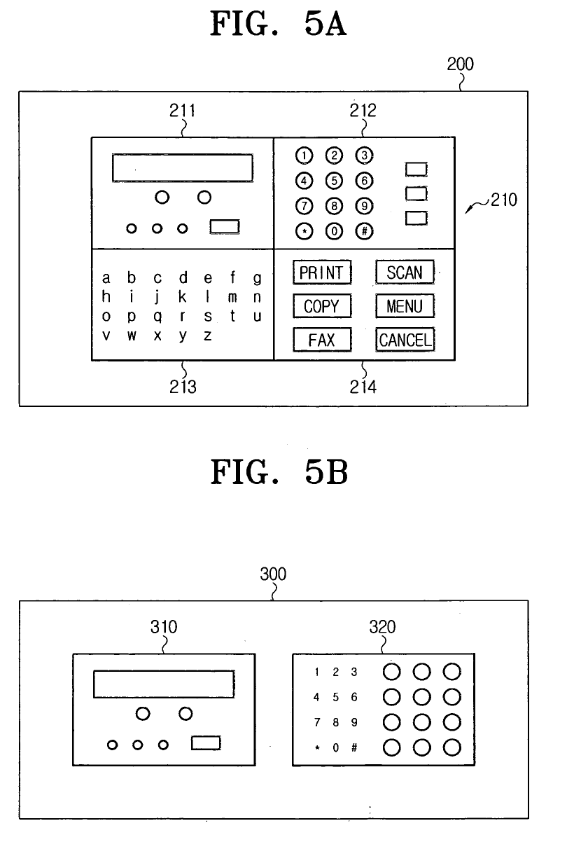

FIGS. 5A and 5B are views illustrating an image forming apparatus according to another embodiment of the present general inventive concept.

FIG. 5A illustrates an operation panel 210 divided into four (4) panels 211, 212, 213, and 214. A connector connected with each panel has four (4) sockets which correspond to the respective panels 211, 212, 213 and 214. The structure of the connector and a connecting method thereof will be omitted since they were described with reference to FIG. 3 and FIG. 4.

As illustrated in FIG. 5B, an output panel 310 and an input panel 320 may be placed apart from each other by a predetermined distance on a body 300. A user can switch positions of the output panel 310 and the input panel 320 by detaching the output panel 310 and the input panel 320 from a body 300 and attaching one in place of the other.

As described above, a user can change the positions of the panels 121, 122, and 123 of FIG. 2 by disconnecting the panels 121, 122, and 123 from the connectors 111, 112, and 113 and then connecting the panels 121, 122, and 123 with the connectors in a desired order, as illustrated in FIGS. 4A, 4B and 4C. The image forming apparatus 100 has to be provided with the plurality of connectors 111, 112, and 113, each being connectible with the panels 121, 122, and 123 to allow alternative arrangements of the panels 121, 122, and 123.

According to the present general inventive concept, it is possible to divide an operation panel of an image forming apparatus into a predetermined number of panels initially arranged at a plurality of positions and then to change the positions of the panels. That is, a user can determine the positions of the panels in a desired order according to a user's habit or a number of times per period of using a panel type corresponding to a certain function. Accordingly, a user's convenience in manipulating the image forming apparatus can be improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
a body;
a plurality of connectors formed at a plurality of predetermined positions on the body; and
a plurality of operation panels connected with the body through the plurality of connectors at connecting positions thereof,
wherein the connecting positions of the plurality of operation panels are changeable.

2. The image forming apparatus as claimed in claim 1, wherein the body comprises a plurality of bus lines that correspond to the plurality of operation panels.

3. The image forming apparatus as claimed in claim 2, wherein each connector of the plurality of connectors is connectible with any operation panel of the plurality of operation panels.

4. The image forming apparatus as claimed in claim 3, wherein each connector of the plurality of connectors comprises a plurality of sockets which is connectible with the plurality of operation panels and, if the connector is connected with one of the plurality of operation panels, connects the connected operation panel with a corresponding at least one bus line.

5. The image forming apparatus as claimed in claim 4, wherein each socket of the plurality of sockets is distinguishable from one another to distinguish operation panels connected with the respective sockets.

6. The image forming apparatus as claimed in claim 5, wherein the sockets of the plurality of sockets have different colors from one another.

7. The image forming apparatus as claimed in claim 1, wherein the plurality of operation panels comprises:
at least one input panel to input a predetermined input signal; and
at least one output panel to display an operation status according to the predetermined input signal.

8. An image forming apparatus comprising:
a body; and
an operation panel connected with the body,
wherein the operation panel is divided into a predetermined number of panels, and the panels are changeable in position with respect to the body.

9. The image forming apparatus as claimed in claim 8, wherein the body comprises:
a plurality of bus lines corresponding to the panels; and
a plurality of sockets to connect any panel of the operation panel with a corresponding at least one bus line of the plurality of bus lines.

10. A method of changing positions of panels in an image forming apparatus which has a plurality of panels, the method comprising:
preparing a plurality of connectors on the image forming apparatus, each connector of the plurality of connectors being connectible with the plurality of panels; and
changing positions of the plurality of panels and connecting the plurality of panels with the plurality of connectors.

11. The method as claimed in claim 10, wherein each connector of the plurality of connectors is connectible with the plurality of panels and has a plurality of sockets which, if the connector is connected with one of the plurality of panels, connects the connected panel with a corresponding at least one bus line.

12. The method as claimed in claim 11, wherein each socket of the plurality of sockets is distinguishable from one another to distinguish a panel from the plurality of panels connectable with the respective sockets.

13. The method as claimed in claim 12, wherein the plurality of sockets have different colors from one another.

14. The method as claimed in claim 10, wherein the plurality of panels comprises:
at least one input panel to input a predetermined input signal; and
at least one output panel to display an operation status according to the predetermined input signal.

15. An image forming apparatus interface to perform input and output operations, the image forming apparatus interface comprising:
a plurality of panels, at least two panels of the plurality of panels being changeable in position with each other; and
a plurality of connectors disposed thereon to connect with the plurality of panels, at least two of the plurality of connectors being connectable with the at least two panels.

16. The image forming apparatus interface as claimed in claim 15, wherein each of the plurality of connectors comprises a plurality of sockets to connect with any panel of the plurality of panels.

17. The image forming apparatus interface as claimed in claim 16, wherein each socket of the plurality of sockets is connectable with one corresponding panel of the plurality of panels.

18. The image forming apparatus interface as claimed in claim 17, wherein each socket of the plurality of sockets is connected with at least one bus line from a plurality of bus lines corresponding to the one corresponding panel of the plurality of panels.

19. An image forming apparatus comprising:
a body;
an operation panel to perform input and output operations and including a plurality of panels, at least two of the plurality of panels being changeable in position with respect to each other;
a plurality of connectors disposed at a plurality of locations on the body, each connector capable of connecting to one or more of the plurality of panels; and
a plurality of bus lines, at least one bus line corresponding to each panel of the plurality of panels.

20. The image forming apparatus as claimed in claim 19, further comprising:
a connecting part, the plurality of locations on the body being disposed at the connecting part.

21. The image forming apparatus as claimed in claim 19, further comprising:
a main controller to communicate with the plurality of panels through the plurality of bus lines and to control image forming operations.
